(19) United States
(12) Patent Application Publication
(10) Pub. No.: US 2020/0288355 A1
(43) Pub. Date: Sep. 10, 2020

(54) SYSTEM AND USER EQUIPMENT

(71) Applicant: GUANGDONG OPPO MOBILE TELECOMMUNICATIONS CORP., LTD., Dongguan (CN)

(72) Inventors: Jianhua LIU, Dongguan (CN); Yang XU, Dongguan (CN)

(73) Assignee: GUANGDONG OPPO MOBILE TELECOMMUNICATIONS CORP., LTD., Dongguan (CN)

(21) Appl. No.: 16/883,957

(22) Filed: May 26, 2020

Related U.S. Application Data
(63) Continuation of application No. PCT/CN2018/117771, filed on Nov. 27, 2018.
(60) Provisional application No. 62/590,990, filed on Nov. 27, 2017.

(51) Int. Cl. H04W 36/00; H04W 36/30; H04W 76/19; H04W 68/00

(52) U.S. Cl. CPC H04W 36/0022; H04W 68/005; H04W 76/19; H04W 36/30

(57) ABSTRACT

A System (201) comprising a data handle device (209, 209′) is provided, wherein the data handle device (209, 209′) is adapted to detect a switch over of a connection with a user equipment (203) to another system (202) and wherein the data handle device (209, 209′) is further adapted to forward data for the user equipment (203) to the other system (202) during the time the connection with the user equipment (203) is switched over to the other system (202).

### CROSS-REFERENCE TO RELATED APPLICATION

This application is a U.S. continuation application of International Application No. PCT/CN 2018/117771, entitled “SYSTEM AND USER EQUIPMENT”, filed on Nov. 27, 2018, which claims priority to U.S. provisional application No. 62/590,990, filed on Nov. 27, 2017, the disclosures of which are hereby incorporated by reference in their entireties.

### BACKGROUND

A characteristic of 5G is the ability to support different devices and services with different performance and data traffic models such as IP data traffic, non-IP data traffic, and short data bursts such as for example in Internet of Things based applications. In such applications sensors may send data packages ranging in size from a small status update to streaming video, or modem telephones such as smart phones may generate widely varying amounts of data. In contrast to 4G, the architecture of 5G is not only designed for large amounts of data and thus also supports short data bursts without the need for lengthy signaling procedures before and after sending a small amount of data. Cloud applications like cloud robotics may perform computation in the network rather than in a device and therefore may require low end-to-end latencies and high data rates.

Different devices may also have different mobility requirements. Sensors embedded in infrastructure may be stationary during their entire usable life. Other devices may be stationary during active periods, but nomadic between activations or other devices may be fully mobile.

Some applications may also have varying requirements for the network to hide the effects of mobility. For example, applications such as voice telephony may rely on the network to ensure seamless mobility, whereas applications such as video streaming may use their own functionalities to handle service delivery interruptions during mobility (e.g. buffering).

The document 3GPP TS 23.501 V0.5.0 (2017-05) of the 3rd Generation Partnership Project with the title “Technical Specification Group Services and System Aspects; System Architecture for the 5G System; Stage 2 (Release 15)” defines the Stage 2 system architecture for the 5G System.

The document 3GPP TS 23.502 V0.6.0 (2017-08) of the 3rd Generation Partnership Project with the title “Technical Specification Group Services and System Aspects; Procedures for the 5G System; Stage 2 (Release 15)” defines the Stage 2 procedures and Network Function Services for the 5G system architecture.

### SUMMARY

It is therefore an object of the present disclosure to provide for an efficient transport of data through a network. In an example data may be traffic and in particular user traffic.

The embodiments of the present disclosure provide a system, a user equipment and a method for controlling a connection in a user equipment.

According to an aspect of the present disclosure a system is provided, comprising a data handle device and a transceiver. The data handle device is adapted to detect that a user equipment needs to switch a communication from the system to another system. The data handle device is further adapted to notify the transceiver to forward data of the user equipment to the other system while the connection between the user equipment and the system is suspended.

According to another aspect of the present disclosure a user equipment is provided comprising a connection control device and a transceiver. The connection control device is adapted to determine whether the user equipment needs to switch communication from a first system to a second system. The connection control device is further adapted to suspend the connection between the user equipment and the first system and to switch the communication to the second system if the user equipment needs to switch the communication from the first system to the second system. The transceiver is adapted to receive data from the second system.

According to a further aspect of the present disclosure a method for controlling a connection in a user equipment is provided, comprising determining whether the user equipment needs to switch communication from a first system to a second system, suspending the connection between the user equipment and the first system and switching the communication to the second system if the user equipment needs to switch the communication from a first system to a second system. The method further comprises receiving data from the second system.

### BRIEF DESCRIPTION OF DRAWINGS

Further embodiments of the disclosure are described in the following description of the Figures. The disclosure will be explained in the following in detail by means of embodiments and with reference to the drawing in which is shown:

FIG. 1a shows a UE connected to two systems using a single Receive mode of the UE according to some embodiments of the present disclosure.

FIG. 1b shows an UE connected to two systems using a Dual Receive/Single Transmit mode of the UE according to some embodiments of the present disclosure.

FIG. 1c shows an UE connected to two systems using a Dual Receive/Dual Transmit mode of the UE according to some embodiments of the present disclosure.

FIG. 2 shows an arrangement of an UE connected to a first system according to some embodiments of the present disclosure.

FIG. 3 shows an arrangement of an UE connected to a second system after a switch over of a connection between UE and first system to a diverted connection has been executed according to some embodiments of the present disclosure.

### DETAILED DESCRIPTION

In the following the same reference numerals will be used for parts having the same or equivalent function. Any statements made having regard to the direction of a component are made relative to the position shown in the drawing and can naturally vary in the actual position of application.

For the connection between an UE and a system it is possible to use a DR mode. When using DR-mode (Dual Registration) of operation the UE's behavior is impacted by UE's lower layer capability. In the context of this text lower layer capability may be e.g. RF capability or TX/RX capability. The DR-mode is usually used, to allow an UE to connect to two or more systems or network elements simultaneously. In one example the UE can connect to two or more networks using different access technology such as 5G or LTE.

Specifically, an UE can have one of these three lower layer capabilities, i.e. Single Rx, Dual Rx/Single Tx and Dual Rx/Dual Tx.

When the UE is switched into one of these DR-modes, the UE can be registered within two or more networks and communicate with these two or more networks at the same time.

In at least one alternative embodiment, a system is provided, comprising a data handle device and a transceiver, e.g. a system transceiver. In an example the data handle device and the transceiver is a single device. The data handle device is adapted to detect that a user equipment needs to switch a communication from the system to another system, e.g. from a first system to a second system. The data handle device is further adapted to notify the transceiver to forward data of the user equipment to the other system while the connection between the user equipment and the system is suspended.

In an example a system or network element, e.g. a communication system, is provided, comprising a data handle device or traffic handle device. The data handle device is adapted to detect a switch over of a connection with a user equipment and/or of a communication with a user equipment to another system and the data handle device is further adapted to forward data for the user equipment to the other system during the time the connection with the user equipment is switched over to the other system. In other words, the data handle device may seek for a relay device in order to establish a connection and/or a communication with the user equipment at its new position.

The system and/or communication system can comprise a network and/or a network element. In an example the network may be a core network (CN) and/or a radio access network (RAN). The system is connected with the user equipment (UE).

In other words, when the UE is connected to a first system and the UE switches to a second system for communication while the connection and context in the old system is suspended, the first system forwards the data for the UE to the second system, and the second system transmits the data to the UE. The second system may be of the same system type as the first system. Consequently, the data handle device may also be adapted to receive a connection from a system and to forward and/or relay the connection and any data in this connection to the UE.

Thus, the communication between the UE and the first system may be relayed over a second system. In this way it is possible to handle a mobile terminating (MT) call, e.g. a downlink data transmission, during the time period when the UE is tuned away in the first system and the MT data can be processed by the UE even if the UE is not directly reachable. Consequently, the switch over of a connection from a first system to a second system may prevent loss of MT call data for a UE which data arrive at a first system during a time period, when the UE is connected to a second system. Therefore, when the UE tunes away from the first network to the second network and when the downlink data arrive in the first network, the first network can forward the data to the second network so that the downlink data in the first network will not be delayed or discarded. This diversion of the connection prevents that the UE is assessed by the network as being out of reach and thus the UE is still reachable even if it is travelling to another system.

Tuning away or switching over from a first system to a second system may comprise leaving the first network, and additionally, connecting with the second network and thus forming a relay for the connection, at least during the time the UE is connected to the other system. A reason for changing the system may be mobility requirements of the UE.

In at least one alternative embodiment, a user equipment is provided comprising a connection control device or a communication control device and a transceiver, e.g. a user equipment transceiver. The connection control device is adapted to determine whether the user equipment needs to switch communication from a first system to a second system. The connection control device or communication control device is further adapted to suspend the connection between the user equipment and the first system and to switch the communication to the second system when and/or if the user equipment needs to switch the communication from the first system to the second system. The transceiver is adapted to receive data from the second system.

In an example a user equipment is provided. The user equipment comprises a connection control device, wherein the connection control device is adapted to determine whether a switch over of a connection and/or a communication from a first system to a second system is desired. The connection control device is further adapted to suspend the connection and/or a communication to the first system and/or to suspend or store a context of the connection to the first system and to switch the connection over to a second system if and/or when the switch over of the connection from the first system to the second system is desired. The connection control device may also be adapted to suspend or store a context of a user equipment.

A switch over may be desired or needed, when the UE moves around and determines a new network element (NE) which is closer to the UE. The context which is suspended or stored by the connection control device may include the configuration for the UE, e.g., access stratum, non-access stratum context, or UE capabilities. In an example the context may be stored in form of a memory dump of the memory of the UE.

In at least one alternative embodiment, a method for data handling in a system is provided, comprising detecting that a user equipment needs to switch communication from the system to another system and suspending the connection with the user equipment and forwarding data of the user equipment to the other system.

In an example a method for data handling in a system is provided. The data may comprise traffic. The method comprises detecting a switch over of a connection between the system and a user equipment to another system and forwarding data for the user equipment to the other system during the time the connection with the user equipment is switched over to the other system.

In at least one alternative embodiment, a method for controlling a connection in a user equipment is provided, comprising determining whether the user equipment needs to switch communication from a first system to a second system, suspending the connection between the user equipment and the first system and switching the communication to the second system if and/or when the user equipment needs to switch the communication from a first system to a second system. The method further comprises receiving data from the second system.

In an example a method for controlling a connection in a user equipment is provided. The method comprises determining whether a switch over of a connection and/or of a communication from a first system to a second system is desired or needed. The method further comprises suspending the connection to the first system and/or suspending a context of the connection to the first system and switching the connection over to a second system if the switch over of the connection from the first system to the second system is desired.

In at least one alternative embodiment, a program element is provided, which, when being executed by a processor is adapted to carry out one of the inventive methods.

In at least one alternative embodiment, a computer-readable medium comprising program code is provided, which, when being executed by a processor is adapted to carry out one of the inventive methods.

A computer-readable medium may be a floppy disk, a hard disk, an USB (Universal Serial Bus) storage device, a RAM (Random Access Memory), a ROM (read only memory) or an EPROM (Erasable Programmable Read Only Memory). A computer readable medium may also be a data communication network, e.g. the Internet, which may allow downloading a program code.

In an example, the data comprises a paging message and/or user plane data. In another example the data comprises traffic and in particular data traffic. Those data are used for MT calls.

In an example the term data, data traffic and/or data may be used in an exchangeable way. This term may describe information to be exchanged between systems, UEs and/or between a system and a UE.

In an example the data handle device is adapted to obtain information about the other system from the user equipment and/or from the other system.

In an example the data handle device is adapted to obtain information about the other system by an indication of the user equipment and/or an indication of the other system.

The system may obtain the information of the other system in one way of the following examples. In one example, the UE indicates to the first system the second system information when notifying the first system to suspend the connection and context. In another example the second system indicates to the first system this information. Any combination of the examples is also possible. In other words, the information the second system information is information that enables the first system to identify and/or address the second system. By providing the second system information to the first system the first system is able to communicate with the second system.

In one example the system information may be a network index such as a CN ID (Core Network Identifier), a NB ID or a cell ID. In another example the system information may be a network type such as CN type, e.g. 5GC for 5G, EPC (Evolved Packet Core) for LTE. The network type may also be the RAT (Radio Access Technology) type, e.g. EUTRAN (Evolved UTRAN) for LTE, NR (New Radio) for 5G, WLAN, Bluetooth.

In an example, the data or traffic forwarded to the other system comprises at least one of a target user equipment information, a user plane tunnel information and/or a quality of service (QoS) information.

In other words, the system may forward the data to the other system, comprising forwarding information. In one example the forwarding information may be the target UE information, e.g. UE index. In another example the forwarding information may be the user plane tunnel information, e.g. bearer, QoS flow, PDU session, PDN connectivity info. And in yet another example the forwarding information may be QoS (Quality of Service) information.

The forwarding information is transmitted in addition to the data for the UE, e.g. in addition to the data for the UE. The forwarding information is the information indicating how the UE, the system and the other system are linked together. In this way the other system understands which information is to be forwarded to the UE. In one example the data or forwarding information is transparently transmitted to the next node, i.e. to the other system. In another example instead of transparently transmitting this data, a data frame may be used which is defined for the forwarding tunnel.

In an example, the data handle device is adapted to convert the data from the format of the system, e.g. the format of a first system, to the format of the other system before the transceiver, e.g. the system transceiver, forwards the data of the user equipment to the other system.

In an example the data handle device is adapted to reformat the data which is forwarded to the other system.

In one example, if the forwarding information is formatted as the second system, the first system converts the information from the first system format to the second system format. In another example, if the forwarding information is formatted as the first system, the second system converts the information from the first system format to the second system format.

In other words, the data handle device is adapted to reformat the format between the format of the system and of the other system. Thus, if the two systems may have different formats for transporting the information a reformatting and/or conversion is executed. In an example in 5GS (5G System), the connection between UE and system, e.g. the core network, may use a PDU (Protocol Data Unit) session, but the other system may be based on Evolved Packed System (EPS) and in this case the connection between UE and other system is a PDN (Packet Data Network) connection. In this example the data handle device of the system converts to a PDU session and/or the data handle device of the other system converts to a PDN connectivity.

In an example, the data handle device is adapted to suspend a context of the user equipment.

In an example the data handle device is adapted to convert the data which is forwarded.

In a further example the system and/or the other system converts the forwarding information using a predefined rule or a pre-configured rule. The pre-configured rule defines in an example how to map between PDN connectivity and PDU session and/or how to map between 5GS QoS and EPS QoS.

In yet another example the data handle device is adapted to indicate the forwarded data as being originating from the system.

In a further example the other system transmits the data forwarded from the system to the UE and indicates in the transmitted that the data is originating from the system. In this way the UE can determine that the received data is data from the system and only forwarded and/or relayed by the other system. This indication will inform the UE that the data is from the network belonging to the system, and the lower layer of the UE will deliver the data to the corresponding upper layer, i.e. the upper layer belonging to the connection between the UE and the system, which connection may be inactive on a physical layer.

In an example the data and/or traffic is a paging message. If the data is a paging message, the UE responds paging to the first system via resuming the first system connection or via the second system connection.

In other words, if the UE receives a paging message via the second system the UE can in one example respond to the paging message via the active connection between the UE and the second system. In another example, if the UE receives a paging message via the second system, the UE can reactivate and resume the inactive connection between UE and the first system and responds to the paging message via the re-established connection between the UE and the first system. Which option is used depends on the design of the UE or by an indication which is sent to the UE from the system or network. This indication may be included in the paging message.

In an example the connection control device is further adapted to determine whether the user equipment needs to switch the communication from the second system to the first system and the connection control device is further adapted to resume the connection between the user equipment and the first system and to switch the communication to the first system if the user equipment needs to switch communication from the second system to the first system.

In an example the connection control device is adapted to determine whether a switch over of the connection from the second system to the first system is desired and to resume the connection to the first system and/or the context of the connection to the first system and to switch the connection over to the first system if the switch over of the connection from the second system to the first system is desired.

In order to switch over the connection from the second system to the first system it may be necessary that before ahead a switch over and/or tuning away from the first system to the second system has have happened.

In an example the transceiver is adapted to receive an indication from the second system, wherein the indication indicates that the data is from the first system.

In an example the connection control device is further adapted to determine a type of the data received by the UE inside the connection to the second system and to decide to use one of the connection to the first system or the connection to the second system dependent on the type of the received data. The connection to the second system is the connection between UE and second system.

If the data type of the received data is a paging message from the first system, the UE responds with a paging response message to the first system. For sending this response paging message the UE may either resumes and/or re-establishes the connection to the first system and sends the response paging message via this re-established connection or the UE uses the existing connection to the second system and sends the response paging message via the second system connection to the first system.

In another example the connection control device may be further adapted to determine a type of the data and/or of the traffic received in the connection to the second system and to decide to use the connection to the first system or the connection to the second system dependent of the type of the received traffic and/or the type of the data.

In an example, in the method for data handling and/or in the method for controlling a connection and/or a communication in a user equipment the data comprises a paging message and/or user plane data.

In an example, in the method for data handling further comprises obtaining information about the other system from the user equipment and/or from the other system.

In an example, in the method for data handling further comprises suspending the context of the user equipment.

It has to be noted that aspects of the disclosure have been described with reference to different subject-matters. In particular, some aspects have been described with reference to apparatus type claims whereas other aspects have been described with reference to method type claims. However, a person skilled in the art will gather from the above and the following description that, unless other notified, in addition to any combination between features belonging to one type of subject-matter also any combination between features relating to different types of subject-matters is considered to be disclosed with this text. In particular, combinations between features relating to the apparatus type claims and features relating to the method type claims are considered to be disclosed.

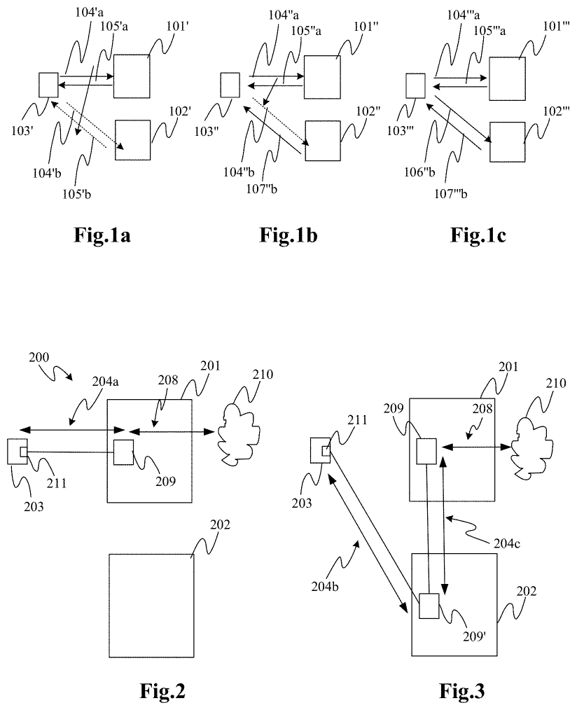

FIG. 1a shows an UE 103′ connected to two systems 101′, 102′ using a single Rx (Receive) mode of the UE according to some embodiments of the present disclosure. The first system 101′ and the second system 102′ may be seen as an access node to a corresponding first network and second network, respectively. With this single Rx capability, the UE 103′ can actively send and receive in only one system 101′, 102′. In order to check the paging channel in the other system and/or to perform any other activity in the other system, such as periodic registration update, the UE needs to “tune away” from the current system.

A paging channel can be identified via monitoring a physical control channel, e.g. PDCCH channel addressed by specific RNTI (Radio Network Temporary Identifier), e.g. P-RNTI (Paging-RNTI). The RNTI can be seen as a UE ID within a channel between a system and an UE.

As indicated by solid lines for the transmit path (Tx) 104′a and receive path (Rx) 105′a only this connection to the first system 101′ and/or communication to the first system 101′ can be maintained at the same time. If a connection and/or communication to the second system 102′ is desired the UE 103′ has to tune away from the first system and to switch over to the second system 102′, using the second transmit path (Tx) 104′b and the second receive path (Rx) 105′b, indicated by a dotted line, because these connections cannot be used simultaneously with the first connection 104′a, 105′a.

FIG. 1b shows an UE connected to two systems using a Dual Rx/Single Tx (transmit) mode of the UE according to some embodiments of the present disclosure.

With this Dual Rx/Single Tx capability the UE 103″ can listen to the paging channel in the other system 102″ while simultaneously being active in the current system. If the UE 103″ needs to respond to a paging message in the other system or needs to perform any other activity in the other system, such as periodic registration update, the UE 103″ again needs to “tune away” from the current system.

In the Dual Rx/Single Tx mode the UE 103″ can use first transmit path 104″a and the first receive path 105″a simultaneously with the second receive path 107″b. In order to use the second transmit path 104″b the first transmit path 104″a has to be switched from the first system 101″ over to the second system 102″.

FIG. 1c shows an UE connected to two systems using a Dual Rx/Dual Tx mode of the UE according to some embodiments of the present disclosure.

With this Dual Rx/Dual Tx capability the UE 103′″ can simultaneously send and receive in both systems 101′″, 102′″.

In other words, in the Dual Rx/Dual Tx mode the UE 103′″ can use the first transmit path 104′″a and the first receive path 105′″ a simultaneously with the second transmit path 106′″b and the second receive path 107′″b. First transmit path 104′″a and first receive path 105′″a form a first connection between the UE 103′″ and the first system 101″. Second transmit path 106′″b and second receive path 107′″b form a second connection between the UE 103′″ and the second system 102′″.

As described above, UEs 103′, 103″ with Single Rx or Dual Rx/Single Tx need to “tune away” from the current system 101′, 101″ while performing transmission in the other system 102′, 102″, because the UE can transmit over only one RAT (Radio Access Technology).

This implies that a UE 103′, 103″ has to autonomously release the connection and/or communication to the current system 101′, 101″ and make an access to the other system 102′, 102″. From the network perspective, the UE will seem to have gone out of coverage. While networks can handle UEs going out of coverage, it can impact network algorithms and KPIs (Key Performance Indicator).

When UE 103′, 103″ tunes to the other system 102′, 102″, UE 103′, 103″ can suspend the current system connection and context and resume it when coming back. During the suspend time, when a MT call arrives, it is not clear how to handle the case.

A solution is provided to let the UE 103′, 103″ respond to a MT call even if the network cannot see the UE because for the network, the UE is not connected and/or covered any more.

The present disclosure proposes the paging or the downlink data forwarding from the old (first) system 101′, 101″ to the new (second) system 102′, 102″, and the paging or the downlink data is transmitted to the UE 103′, 103″ via the second system 102′, 102″. If a connection is switched from the first system 101′, 101″ to the second system 102′, 102″, the first system 101′, 101″ is the old system and the second system 102′, 102″ is the new system. In other words, the system releasing a connection and/or a communication may be designated as the old system. The system receiving a connection and/or a communication is designated as the new system.

In other words, the present disclosure shows a way of MT data handling when UE tunes away. In particular the present disclosure shows a solution for the Single Rx mode and/or the Dual Rx/Single Tx mode, where at least one transmit and/or one receive path has/have been disconnected from the first network.

Since the paging data, paging information, paging traffic and/or paging data is directed from the network to the UE, paging data is one example for MT data. MT data is terminating at a mobile station and/or terminating at the UE.

FIG. 2 shows an arrangement of an UE connected to a first system according to some embodiments of the present disclosure.

In this arrangement, UE 203 and system 201 are shown. UE 203 may only be able to implement Single Rx mode and/or the Dual Rx/Single Tx mode if a connection to the other system 202 is to be established. A reason for establishment of a connection to the other system 202 may be a movement of the UE 203 or a different access technology that is implemented by the other system 202 compared to the system 201. The first system 201 and the second system 202 may be the same type of system, for example an access node to a network 210.

The system 201 or first system 201 comprises a data handle device and a transceiver (not shown in FIG. 2). The data handle device 209 is adapted to detect that a user equipment 203 needs to switch a communication 204a and/or a connection 204a from the first system 201 to another system 202, e.g. to a second system 202. The data handle device 209 is further adapted to notify the transceiver to forward data of the user equipment 203 to the other system 202 while the connection between the user equipment and the system is suspended. In an example a communication is transmitted over a connection.

The first system 201 comprises a data handle device 209. A UE can connect to the network 210 via the first access connection 204a and/or via the first access communication 204a and the backbone connection 208 and/or the backbone communication 208. The data handle device 209 links the first access connection 204a and/or the first access communication 204a and the backbone connection 208. The data handle device 209 is adapted to detect that a user equipment 203 needs to switch a communication 204a from the system 201 to another system 202. In an example the data handle device 209 is adapted to detect a switch over of a connection 204a with a user equipment (UE) 203 to another system 202. And the data handle device 209 is further adapted to notify the transceiver of the system to forward data of the user equipment 203 to the other system 202 while the connection between the user equipment and the system is suspended. In an example the data handle device 209 is adapted to forward data for the UE 203 to the other system 202 during the time the connection with the user equipment is switched over to the other system 202. The access connection 204a and/or the access communication 204a can be a single Tx 104″a connection, a single Tx 104″a communication, a bidirectional Tx/Rx communication 104′a, 105′a and/or a bidirectional Tx/Rx connection 104′a, 105′a. Such single connections and/or communications may only be connected to a single system 201, 202 at the same time and therefore have to be connected to the respective access system 201, 202 via which the UE desires and/or needs to send information. In FIG. 2, UE 203 can only send information, data and/or data traffic to the network 210 via the first system 201.

The user equipment 203 comprises a connection control device 211 or a communication control device 211 and a UE transceiver (not shown in FIG. 2). The connection control device 211 or communication control device 211 is adapted to determine whether the user equipment 203 needs to switch a communication from the first system 201 to the second system 202. The connection control device 211 or the communication control device 211 is adapted to suspend the connection 204a and/or the communication 204a between the user equipment 203 and the first system 201 and to switch the connection 204a and/or the communication 204a to the second system 202 if the user equipment 203 needs to switch the communication from the first system 201 to the second system 202. The transceiver is adapted to receive data from the second system 202.

In an example the user equipment 203 comprises a connection control device 211 or a communication control device 211, wherein the connection control device 211 or communication control device 211 is adapted to determine whether a switch over of a connection 204a from a first system 201 to a second system 202 is desired. The connection control device 211 is adapted to suspend the connection to the first system 201 and/or a context of the connection to the first system 211 and to switch the connection 204a over to a second system 202 if and/or when the switch over of the connection from the first system to the second system is desired.

After a switch over, a rerouting and/or a tuning over of the connection 204a or of the communication 204a to the second system 202 took place the arrangement of FIG. 3 appears. FIG. 3 shows an arrangement of an UE 203 connected to a second system 202 according to some embodiments of the present disclosure after a switch over of connection 204a and/or of a communication 204a between UE and first system 201 to a diverted connection 204b and/or to a diverted communication 204b took place. The diverted connection 204b and/or the diverted communication 204b connects UE 203 with the second system 202. In this configuration the data handle device 209 has established the inter system connection 204c or the inter system communication between the first data handle device 209 and the second handle device 209′.

Even if the first and second data handle devices 209, 209′ are of the same type, in FIG. 3 both data handle devices 209, 209′ are operated in a different mode.

The first data handle device 209 is operated in a backbone forward mode. In this mode the first data handle device 209 receives and/or transmits data from/to the network 210 and maps the data between intersystem connection 204c and backbone connection 208.

The second data handle device 209′ is operated in a UE forward mode. In this mode the second data handle device 209′ receives and/or transmits data from/to the UE 203 and maps the data between diverted access connection 204b and inter system connection 204c and/or maps the data between diverted access communication 204b and inter system communication 204c.

In the diverted arrangement according to FIG. 3, connection control device 211 or communication control device 211 as well as the first data handle device 209 have stored and/or suspended the context of the original connection 204a, of the original communication 204a, of the first communication 204a and/or of the first connection 204a in order to be able to re-establish the connection and/or the communication between UE 203 and first system 201. The stored and/or suspended context in an alternative example may be and/or comprise context of the UE.

Such re-establishment of the first connection may be necessary after the UE 203 will received an MT data message, such as a paging information.

Even if the data handle device 209 and the connection control device 211 are shown as separate devices or specific units an existing device or unit of the UE 203 or system 201, 202 may be extended to handle respective features.

The connections 204a and 208 or the connections 204b, 204c, 208 transport payload information in the downstream direction, i.e. the direction from network 210 to UE 203. These connections and/or communications form a forwarding tunnel which needs to be established for this purpose. Therefore, the two systems 201, 202 maintain the connection even when no data are transmitted.

It should be noted that the term “comprising” does not exclude other elements or steps and the “a” or “an” does not exclude a plurality. Also, elements described in association with different embodiments may be combined.

It should also be noted that reference signs in the claims shall not be construed as limiting the scope of the claims.

### LIST OF REFERENCE NUMERALS

101′ first system using Single Rx mode
102′ second system using Single Rx mode
103′ UE using Single Rx mode
104′a first transmit path (Tx) using Single Rx mode
105′a first receive path (Rx) using Single Rx mode
104′b second transmit path (Tx) using Single Rx mode
105′b second receive path (Rx) using Single Rx mode
101″ first system using Dual Rx/Single Tx mode
102″ second system using Dual Rx/Single Tx mode
103″ UE using Dual Rx/Single Tx mode
104″a first transmit path (Tx) using Dual Rx/Single Tx mode
105″a first receive path (Rx) using Dual Rx/Single Tx mode
104″b second transmit path (Tx) using Dual Rx/Single Tx mode
107″b second receive path (Rx) using Dual Rx/Single Tx mode
101′″ first system using Dual Rx/Dual Tx mode
102′″ second system using Dual Rx/Dual Tx mode
103′″ UE using Dual Rx/Dual Tx mode
104′″ a first transmit path (Tx) using Dual Rx/Dual Tx mode
105′″ a first receive path (Rx) using Dual Rx/Dual Tx mode
106″b second transmit path (Tx) using Dual Rx/Dual Tx mode
107″b second receive path (Rx) using Dual Rx/Dual Tx mode
200 arrangement
201 first system
202 second system
203 UE
204a access connection, access communication
204b diverted access connection, diverted access communication
204c inter system connection, inter system communication
208 backbone connection, backbone communication
209, 209′ data handle device or traffic handle device
210 network
211 connection control device

1. System (201) comprising:
a data handle device (209, 209′);
a transceiver;
wherein the data handle device (209, 209′) is adapted to detect that a user equipment (203) needs to switch a communication (204a) from the system (201) to another system (202); and
wherein the data handle device (209, 209′) is further adapted to notify the transceiver to forward data of the user equipment (203) to the other system (202) while the connection between the user equipment and the system is suspended.

2. The system (201) of claim 1, wherein the data comprises a paging message and/or user plane data.

3. The system (201) of claim 1, wherein the data handle device (209, 209′) is adapted to obtain information about the other system (202) from the user equipment (203) and/or from the other system (202).

4. The system (201) of claim 1, wherein the data forwarded to the other system (202) comprises at least one of user equipment information, user plane tunnel information or quality of service information.

5. The system (201) of claim 1, wherein the data handle device (209, 209′) is adapted to convert the data from the format of the first system to the format of the other system before the transceiver forwards the data of the user equipment (203) to the other system (202).

6. The system (201) of claim 1, wherein the data handle device (209, 209′) is adapted to suspend context of the user equipment (203).

7. The system (201) of claim 1, wherein the data handle device (209, 209′) is adapted to resume the communication (204a) between the user equipment and the system (201) if it is detected that the user equipment (203) needs to switch communication from the other system (202) to the system (201).

8. The system (201) of claim 1, wherein the data handle device (209, 209′) is adapted to indicate the forwarded data as being originating from the system (201).

9. User equipment (203) comprising:
a connection control device (211);
a transceiver;
wherein the connection control device (211) is adapted to determine whether the user equipment (203) needs to switch communication from a first system (201) to a second system (202); and
wherein the connection control device is adapted to suspend the connection (204a) between the user equipment (203) and the first system (201) and switch the communication to the second system (202) if the user equipment (203) needs to switch communication from a first system (201) to a second system (202);
the transceiver is adapted to receive data from the second system.

10. The user equipment (203) of claim 9, wherein the connection control device (211) is further adapted to determine whether the user equipment (203) needs to switch the communication from the second system (202) to the first system (201); and
wherein the connection control device (211) is further adapted to resume the connection (204a) between the user equipment and the first system (201) and to switch the communication to the first system (201) if the user equipment (203) needs to switch communication from the second system (202) to the first system (201).

11. The user equipment (203) of claim 9, wherein the transceiver is adapted to receive an indication from the second system (202), wherein the indication indicates that the data is from the first system (201).

12. The user equipment (203) of claim 9, wherein the data comprises a paging message.

13. The user equipment (203) of claim 9, wherein the user equipment (203) is adapted to indicate to the first system (201) information about the second system (202).

14. The user equipment (203) of claim 9, wherein the connection control device (211) is adapted to suspend context of the user equipment (203).

15. A method for controlling a connection in a user equipment, comprising:
determining whether the user equipment (203) needs to switch communication from a first system to a second system;
suspending the connection between the user equipment (203) and the first system; and
switching the communication to the second system (202) if the user equipment (203) needs to switch communication from a first system (201) to a second system (202);
receiving data from the second system.

16. The method of claim 15, wherein the method further comprises:
determining whether the user equipment needs to switch the communication from the second system to the first system; and
resuming the connection between the user equipment and the first system and switch the communication to the first system if the user equipment needs to switch communication from the second system to the first system.

17. The method of claim 15, wherein the method further comprises:
receiving an indication from the second system, wherein the indication indicates that the data is from the first system.

18. The method of claim 15, wherein the data comprises a paging message.

19. The method of claim 15, wherein the method further comprises:
indicating to the first system (201) information about the second system (202).

20. The method of claim 15, wherein the method further comprises:
suspending context of the user equipment (203).
